(19) United States
(12) Patent Application Publication
(10) Pub. No.: US 2015/0193410 A1
(43) Pub. Date: Jul. 9, 2015

(54) SYSTEM FOR EDITING A TEXT OF A PORTABLE TERMINAL AND METHOD THEREOF

(71) Applicant: Electronics and Telecommunications Research Institute, Daejeon (KR)

(72) Inventors: Yun JIN, Daejeon (KR); Chang Hyun KIM, Daejeon (KR); Young Ae SEO, Daejeon (KR); Jin Xia HUANG, Daejeon (KR); Oh Woog KWON, Daejeon (KR); Seung Hoon NA, Daejeon (KR); Yoon Hyung ROH, Daejeon (KR); Ki Young LEE, Daejeon (KR); Sang Keun JUNG, Daejeon (KR); Sung Kwon CHOI, Daejeon (KR); Jong Hun SHIN, Daejeon (KR); Eun Jin PARK, Daejeon (KR); Kang Il KIM, Daejeon (KR); Young Kil KIM, Daejeon (KR); Sang Kyu PARK, Daejeon (KR)

(21) Appl. No.: 14/485,341

(22) Filed: Sep. 12, 2014

(30) Foreign Application Priority Data
Jan. 8, 2014 (KR) 10-2014-0002556

(51) Int. Cl. G06F 17/24; G06F 3/16; G06F 3/0488; G06F 3/0484

(52) U.S. Cl. CPC G06F 17/24; G06F 3/0484; G06F 3/167; G06F 3/04886; G06F 3/04883

(57) ABSTRACT

The present invention relates to a system for editing a text of a portable terminal and a method thereof, and more particularly to a technology which edits a text which is input into a portable terminal based on a touch interface. An exemplary embodiment of the present invention provides a text editing system of a portable terminal, including: an interface unit which inputs or outputs a text or voice; a text generating unit which generates the input text or voice as a text; a control unit which provides a keyboard based editing screen or a character recognition based editing screen for the generated text through the interface unit; and a text editing unit which performs an editing command which is input from a user through the keyboard based editing screen or the character recognition based editing screen under the control of the control unit.

### CROSS-REFERENCE TO RELATED APPLICATIONS

This application claims priority to and the benefit of Korean Patent Application No. 10-2014-0002556 filed in the Korean Intellectual Property Office on Jan. 8, 2014, the entire contents of which are incorporated herein by reference.

### TECHNICAL FIELD

The present invention relates to a text editing system of a portable terminal and a method thereof, and more particularly to a technology which edits a text which is input into a portable terminal based on a touch interface.

### BACKGROUND ART

In electronic equipment such as a portable phone or personal digital assistants (PDA), a text input method which uses a touch screen which may be configured to have a large size screen without having a keypad instead of a Korean letter input method which uses a key pad according to the related art due to development of information displaying and inputting technology is used often.

Such electronic equipment supports a function which receives a text through voice recognition. However, in a text converting process through the voice recognition, many errors occur. For example, a word spacing error occurs, a vocabulary word which is not intended by a user is erroneously added, a vocabulary word which is intended by a user is not recognized, or vocabulary words are output in an order which is different from the intention of the user in a voice recognizing system based on a language model. In the case of a voice recognizing system based on a language model, the above described errors cause serious problems such that the intention which is desired by the user is not exactly reflected due to a recognition error and insufficient built-in data of the language model.

As described above, in the related art, errors may occur during a text converting process through voice recognition or a text inputting process through a touch screen which results in requiring editing to be performed in some cases.

However, when editing is performed in a portable terminal of the related art, an additional editing function except deletion of text or movement of a cursor may be hard to be performed due to the characteristic of a portable terminal which is currently provided. Even though an editing function which is similar to an editing function of a personal computer is implemented, the editing is performed by the same input method as the personal computer by a text input device. Therefore, in portable electronic equipment having a small sized keyboard button, erroneous input by the user frequently occurs and input is not easy so that it takes a lot of time to input text. Such problems may be more significant when the text is converted through voice recognition that requires a large editing amount.

### SUMMARY OF THE INVENTION

The present invention has been made in an effort to provide a text editing device of a portable terminal which provides an interface which allows a user to easily edit (correct) a result (text) obtained by recognizing voice or inputting a text in a touch based portable terminal and obtains a desired result by a reduced number of touch and action through an editing interface which considers a specific error characteristic which may commonly occur in the result obtained by the voice recognition and a method thereof.

An exemplary embodiment of the present invention provides a text editing system of a portable terminal, including: an interface unit which inputs or outputs a text or voice; a text generating unit which generates the input text or voice as a text; a control unit which provides a keyboard based editing screen or a character recognition based editing screen for the generated text through the interface unit; and a text editing unit which performs an editing command which is input by a user through the keyboard based editing screen or the character recognition based editing screen under the control of the control unit.

The text editing system may further include a touched character recognizing unit which recognizes a character input from the character recognition based editing screen.

The touched character recognizing unit may set a range of a part to be edited in the text and when the range is set, receive and recognize an editing tool symbol.

The text editing system may further include a keyboard recognizing unit which recognizes touch or click of an editing button which is input from the keyboard based editing screen.

The keyboard based editing screen may include: a text part which displays the text; and a keyboard type button part which includes an editing button which is driven in accordance with a touch screen manner.

The keyboard type button part may include at least one of a copy button, a paste button, a delete button, an insert button, a replace button, a dictionary button, a translate button, a search button, a voice recognition button, a number button, and a symbol button.

The keyboard based editing screen may include: a text part which displays the text; and a character recognition input unit in which a range, an editing tool symbol, and a target for action are drawn by a pen or a finger to be input.

The text editing system may further include a voice recognizing unit which recognizes voice input through the interface unit and converts the voice into the text.

The text editing system may further include a storing unit in which the keyboard based editing screen, the character recognition based editing screen, the input text, and a character recognition based editing tool symbol table are stored.

Another exemplary embodiment of the present invention provides a text editing method of a portable terminal, including: displaying a text on a screen; providing a keyboard based editing screen for the text displayed on the screen; selecting a range of a text to be edited from the keyboard based editing screen; and performing a touched or clicked editing command on a text whose range is selected when an editing command button is touched or clicked by a user through the keyboard based editing screen.

The keyboard based editing screen may include: a text part which displays the text; and a keyboard type button part which includes the editing command button.

The editing command button may further include at least one of a replace button, a copy button, a paste button, a delete button, an insert button, a dictionary button, a translate button, a search button, a voice recognition button, a number button, and a symbol button.

Yet another exemplary embodiment of the present invention provides a text editing method of a portable terminal, including: displaying a text on a screen; providing a character recognition based editing screen for the text displayed on the screen; setting a range of a text which is edited in the character recognition based editing screen; receiving and recognizing an editing tool symbol for editing a text in the set range from a user; and performing editing using the recognized editing tool.

The character recognition based editing screen may include: a text part which displays the text; and a character recognition input unit which recognizes an editing range, an editing tool symbol, and an editing action based on a touch interface.

In the setting of a range of a text which is edited, when an editing position or range is selected through the character recognition input unit by the user, a text in the corresponding position of the text part may be activated.

In the receiving and recognizing of an editing tool symbol from the user, when the editing tool symbol is drawn by the user, a meaning corresponding to the drawn editing tool symbol may be determined from an editing tool symbol table which is stored in advance.

The performing of editing may perform editing corresponding to the meaning of the editing tool symbol.

The performing of editing when the editing tool symbol is replace, may receive a new text to be replaced to perform replacement.

Still another exemplary embodiment of the present invention provides a text editing method of a portable terminal, including: displaying an input text on a screen; selecting, by a user, an editing method for the input text; providing a keyboard based editing screen when a keyboard based editing method is selected by the user among the editing methods and providing a character recognition based editing screen when a character recognition based editing method is selected by the user among the editing methods; receiving an editing command from the user through the keyboard based editing screen or the character recognition based editing screen; and performing the input editing command to edit the text.

This technology provides an effect which may conveniently and quickly edit a voice recognition result (text), a translation result, or a text which is directly input by a user in a portable terminal.

### BRIEF DESCRIPTION OF THE DRAWINGS

FIG. 1 is a configuration diagram of a text editing system according to an exemplary embodiment of the present invention.

FIG. 2 is an exemplary diagram of a keyboard based editing screen according to a first exemplary embodiment of the present invention.

FIG. 3 is an exemplary diagram of a character recognition based editing screen according to a second exemplary embodiment of the present invention.

FIG. 4 is a flowchart illustrating a keyboard based editing method according to a first exemplary embodiment of the present invention.

FIG. 5A is an exemplary diagram illustrating an error screen using a keyboard based editing method according to a first exemplary embodiment of the present invention.

FIG. 5B is an exemplary diagram illustrating a corrected screen using a keyboard based editing method according to a first exemplary embodiment of the present invention.

FIG. 6 is a flowchart illustrating a character recognition based editing method according to a second exemplary embodiment of the present invention.

FIG. 7A is an exemplary diagram illustrating a step of setting a range (Range), using a character recognition based editing method according to a second exemplary embodiment of the present invention.

FIG. 7B is an exemplary diagram illustrating a step of selecting an editing tool (Edit) using a character recognition based editing method according to a second exemplary embodiment of the present invention.

FIG. 7C is an exemplary diagram illustrating a step of inputting action (Action) using a character recognition based editing method according to a second exemplary embodiment of the present invention.

FIG. 8 is an exemplary diagram of a character recognition based editing tool according to a second exemplary embodiment of the present invention.

FIG. 9 is a flowchart illustrating a text editing method according to a third exemplary embodiment of the present invention.

FIG. 10 is a configuration diagram of a computer system applied a text editing system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the most preferred exemplary embodiments of the present invention will be described in detail with reference to the accompanying drawings so that those skilled in the art may easily carry out the technical spirit of the present invention.

The present invention is made based on touch based portable equipment (a portable terminal) through which a user directly touches a screen to interact with a machine and a voice recognizing system which converts voice uttered by a user through a microphone device into a text. That is, the user inputs voice to touch based portable equipment and the portable equipment recognizes the input voice and displays a text (character strings) which is a final form thereof, on a screen.

Therefore, the present invention is a technology that provides a touch based keyboard based editing interface and a character recognition based editing interface in order to correct the displayed text so that the user may easily perform editing (insert, correct, delete, and input). Therefore, it is possible to obtain a desired result by a simple method with respect to an error which occurs in a text sentence input through the portable terminal or a multi-language text error which occurs in a voice recognition result.

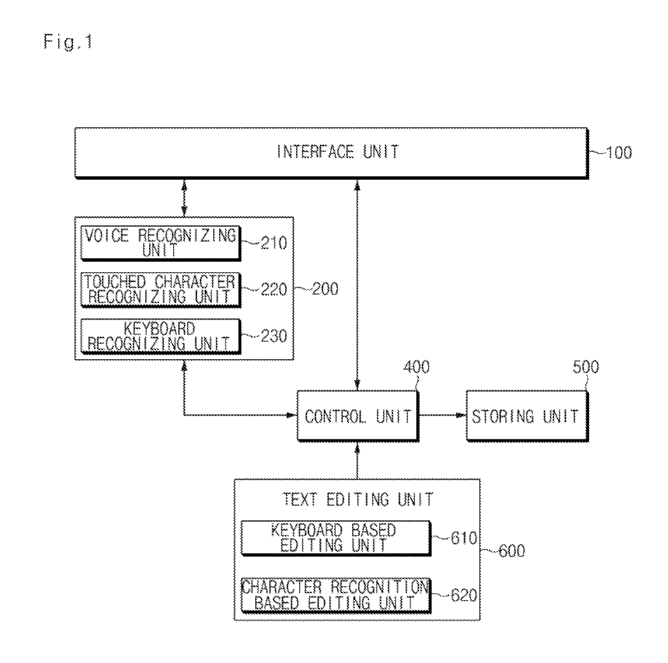

Hereinafter, a text editing system according to an exemplary embodiment of the present invention will be described with reference to FIGS. 1 to 9.

FIG. 1 is a configuration diagram of a text editing system according to an exemplary embodiment of the present invention.

A text editing system according to an exemplary embodiment of the present invention includes an interface unit 100, an input recognizing unit 200, a control unit 400, a storing unit 500, and a text editing unit 600. Here, the text editing system according to an exemplary embodiment of the present invention is produced as an automatic translating application or a voice recognizing application to be installed (loaded) in a portable terminal (or a mobile terminal) to be erasable. Such a portable terminal may include, for example, a cellular phone, a smart phone, a smart pad, a note pad, and a tablet PC.

The interface unit 100 receives a text based on a touch screen or voice from the user. The interface unit 100 outputs a keyboard based editing screen or a character recognition based editing screen under the control of the control unit 400. The interface unit 100 displays a text which is created by a text creating unit 300 on a screen.

The input recognizing unit 200 includes a voice recognizing unit 210 which recognizes a voice which is input to the interface unit 100, a touched character recognizing unit 220 which recognizes characters based on touch, and a keyboard recognizing unit 230 which recognizes keyboard buttons. The voice recognizing unit 210 recognizes a voice which is input through the interface 100 to convert the voice into a text. The touched character recognizing unit 220 recognizes characters and symbols which are input by a pen or a finger based on a touch screen and transmits the information to the control unit 400. The touched character recognizing unit 220 recognizes inputs for an editing range setting, an editing tool symbol, and an action (a target for command) and transmits the result to the control unit 400. The keyboard recognizing unit 230 recognizes a button which is touched or clicked by a user through a keyboard based editing screen which is provided to the interface unit 100 and transmits the information to the control unit 400.

The control unit 400 controls the interface unit 100 to display the text which is input by the user, the text which is converted by the voice recognizing unit 210, the keyboard based editing screen, and the character recognition based editing screen on the screen. The control unit 400 receives a recognition result which is recognized through the touched character recognizing unit 220 or the keyboard recognizing unit 230, such as an editing command, to perform the editing command by interworking with the text editing unit 600. The control unit 400 interworks with the storing unit 500 to store the text in the storing unit 500 or read various interface screens or texts from the storing unit 500.

When an editing request is input from the user through the interface unit 100, the control unit 400 drives a text editing viewer program to provide the keyboard based editing screen or the character recognition based editing screen so as to allow the user to edit the displayed text.

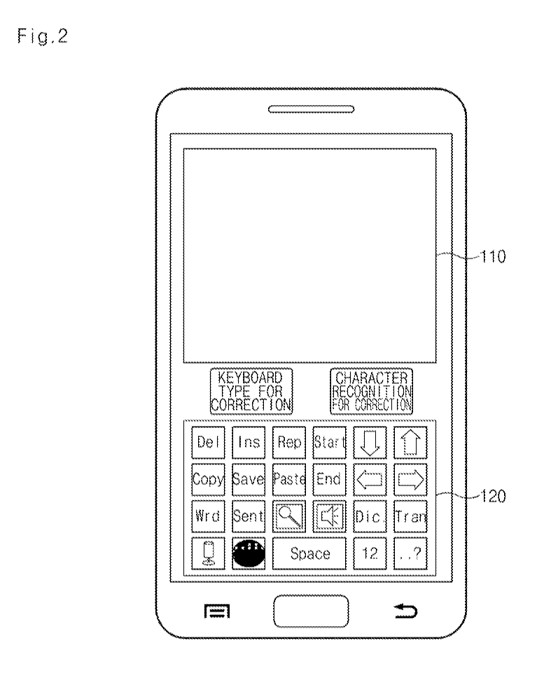

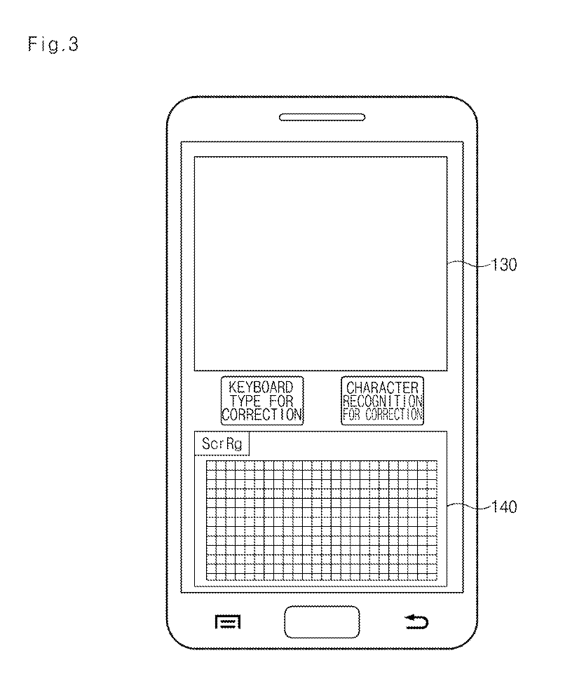

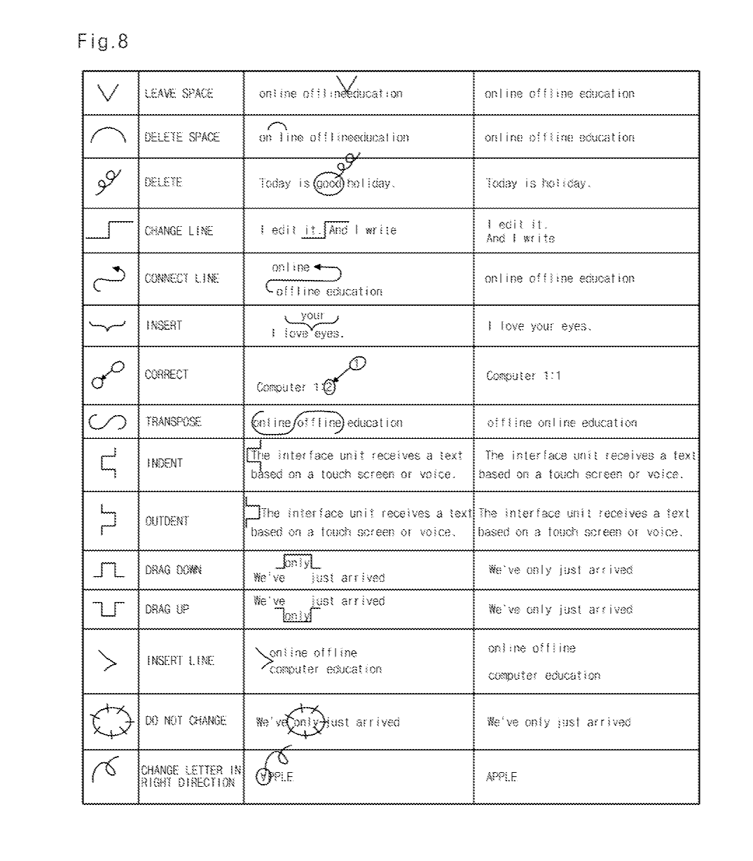

The storing unit 500 stores a text which is input through the interface unit 100, a text which is converted by the voice recognizing unit 210, a text which is edited by the text editing unit 600, the keyboard based editing screen, which is provided to the interface unit, illustrated in FIG. 2, the character recognition based editing screen illustrated in FIG. 3, and a character recognition based editing tool table illustrated in FIG. 8.

In this case, the keyboard based editing screen includes a text part 110 and a keyboard type button part 120 as illustrated in FIG. 2. As illustrated in FIG. 2, the keyboard type button part 120 for editing includes function buttons such as delete (Del), insert (Ins), replace (Rep), start (Start), copy (Copy), save (Save), paste (Paste), end (End), send (Sent), word search (Wrd), dictionary (Dic), and translate (Tran), but is not limited thereto. A button having various editing functions may be added thereto or an unnecessary function may be excluded from the editing buttons illustrated in FIG. 2. In the keyboard type button part 120 of the keyboard based editing screen, a voice input button, a multi-language character input button, a space button, a number input button, and a symbol input button are disposed at the bottom and buttons which edits a specific target such as a word, a sentence, search, a dictionary, and translation are disposed thereon in consideration of a characteristic of the portable terminal Buttons for delete, insert, replace, copy, save, and paste which may be used in many editing tools may be disposed in a first line and a second line and position buttons which indicate a start point and an end point and direction related buttons may be disposed next to the buttons.

In the meantime, the character recognition based editing screen includes a text part 130 and a character recognition input unit 140 as illustrated in FIG. 3. The text part 130 may be disposed in an upper portion of a screen of the portable terminal and the character recognition input unit 140 may be disposed in a lower portion which is an area where a correcting character is recognizable.

The text editing unit 600 edits the text by the editing tool which is input through the interface unit 100. To this end, the text editing unit 600 may include a keyboard based editing unit 610 and a character recognition based editing unit 620.

The keyboard based editing unit 610 performs an editing command for the text in accordance with the recognition result of the keyboard recognizing unit 230 under the control of the control unit 400.

The character recognition based editing unit 620 performs an editing command for the text in accordance with the character recognition result of the character recognition based editing unit 620 under the control of the control unit 400.

As described above, the exemplary embodiment of the present invention has a configuration which provides an interface through which a text may be easily edited.

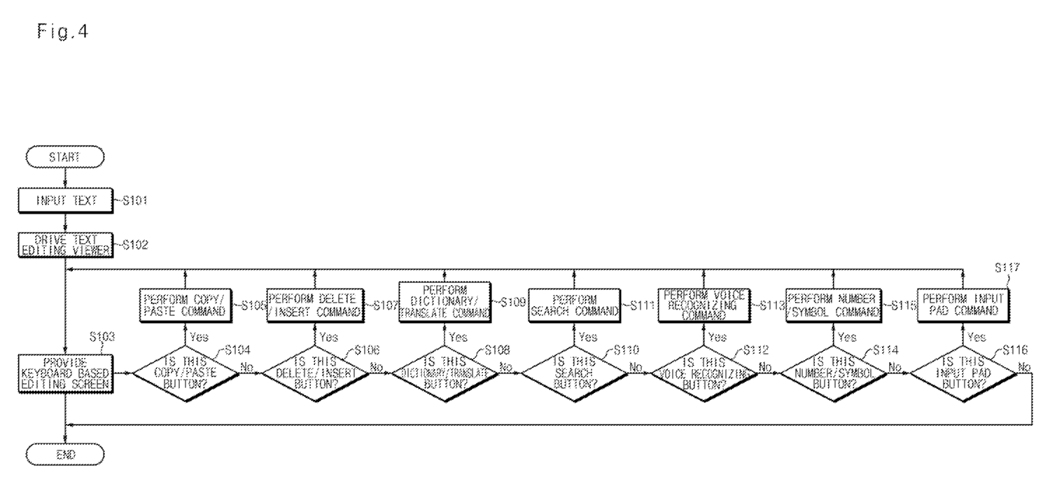

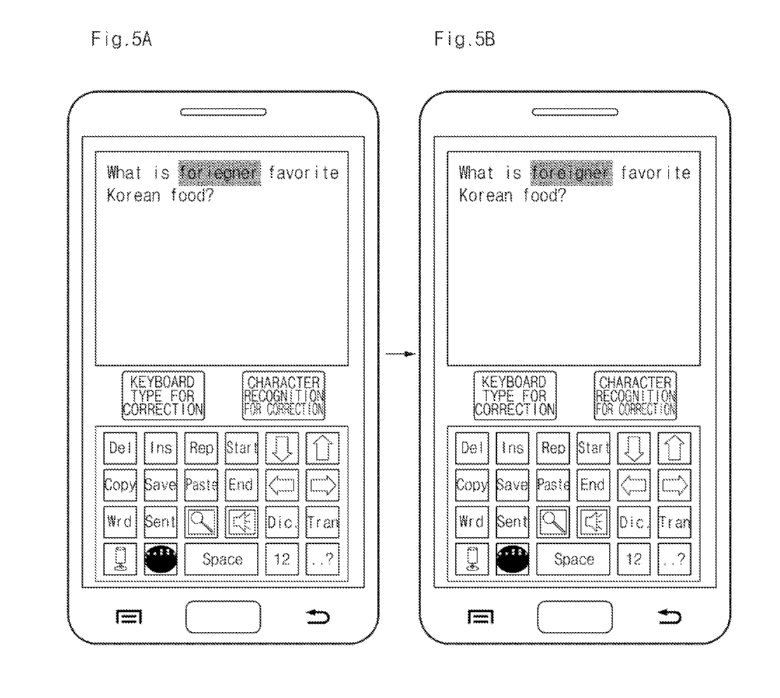

Hereinafter, a keyboard based editing method according to a first exemplary embodiment of the present invention will be described with reference to FIGS. 4 and 5. The keyboard based editing method according to the first exemplary embodiment of the present invention is configured by touching a text to be edited in a sentence and selecting an editing tool function for the touched text from a keyboard.

First, referring to FIG. 4, when a text is input through an interface unit 100 in step S101, a control unit 400 drives a text editing viewer in step S102. In this case, the text editing viewer is a program which provides a text editing screen. In this case, only an example in which a text is directly input is disclosed in FIG. 4, but when a voice is input, a process which converts input voice into a text may be included.

Next, the control unit 400 controls the keyboard based editing screen to be output through the interface unit 100 in step S103 and to receive an editing command from the user through the keyboard based editing screen. In this case, the control unit 400 receives a range of the text to be edited which is set by the user.

The control unit 400 checks whether the user touches or clicks a copy or paste button through a recognition result of a keyboard recognizing unit 230 in step S104 and when the copy or paste button is touched or clicked, the keyboard based editing unit 610 performs a copy or paste command on a selected text in step S105. Next, the keyboard based editing screen is continuously provided to receive the next command in step S103.

In step S104, when the copy or paste button is not touched or clicked, the control unit 400 checks whether the user touches or clicks a delete or insert button in step S106 and when the delete or insert button is touched or clicked, the keyboard based editing unit 610 performs a delete or insert command on the text to be edited in step S107. Next, the keyboard based editing screen is continuously provided again to receive the next command in step S103 and subsequent processes may be repeatedly performed. In this case, the step S103 is repeatedly performed after performing the command so that redundant description will be omitted hereinafter.

In the meantime, when the delete or insert button is not touched or clicked in step S106, the control unit 400 checks whether a dictionary or translate button is touched or clicked through the recognition result of the keyboard recognizing unit 230 in step S108 and when the dictionary or translate button is touched or clicked, the keyboard based editing unit 610 performs a dictionary or translate command on a selected text in step S109.

In the meantime, when the dictionary or translate button is not touched or clicked in step S108, the control unit 400 checks whether a search button is touched or clicked through the recognition result of the keyboard recognizing unit 230 in step S110 and when the search button is touched or clicked, the keyboard based editing unit 610 performs a search command on a selected text in step S111.

In the meantime, when the search button is not touched or clicked in step S110, the control unit 400 checks whether a voice recognition button is touched or clicked through the recognition result of the keyboard recognizing unit 230 in step S112 and when the voice recognition button is touched or clicked, the keyboard based editing unit 610 performs a voice recognition command on a selected text in step S113.

In the meantime, when the voice recognition button is not touched or clicked in step S112, the control unit 400 checks whether a number or symbol button is touched or clicked through the recognition result of the keyboard recognizing unit 230 in step S114 and when the number or symbol button is touched or clicked, the keyboard based editing unit 610 performs a command for inputting a number or a symbol in step S115. In the meantime, when the number or symbol button is not touched or clicked in step S114, the control unit 400 checks whether an input pad button is touched or clicked through the recognition result of the keyboard recognizing unit 230 in step S116 and when the input pad button is touched or clicked, the keyboard based editing unit 610 performs a command for providing an input pad screen in step S117.

In FIG. 4, even though it is described that it is checked whether to touch or click the copy/paste button, the delete/insert button, the dictionary/translate button, the search button/voice recognition button, the number/symbol button, and the input pad button in this order, the order of the editing buttons is not limited thereto but various orders may be presented.

FIG. 5A and FIG. 5B is an exemplary diagram illustrating a process of replacing a text among the keyboard based editing method according to the first exemplary embodiment of the present invention and when the user selects “foriegner” which seems to be an error in a sentence of “What is foriegner favorite Korean food?” and then touches or clicks the replace button (Rep), a text input window is displayed. Next, a text to be replaced “foreigner” is input in the text input window, the erroneous text “foriegner” may be replaced by “foreigner”.

As described above, in the keyboard based editing method according to the first exemplary embodiment of the present invention, a text error area is touched to be selected and then the editing button is selected to perform the editing and also the editing may be performed by a button such as the dictionary (Dic), the translate (Tran), the start, the end, and an arrow.

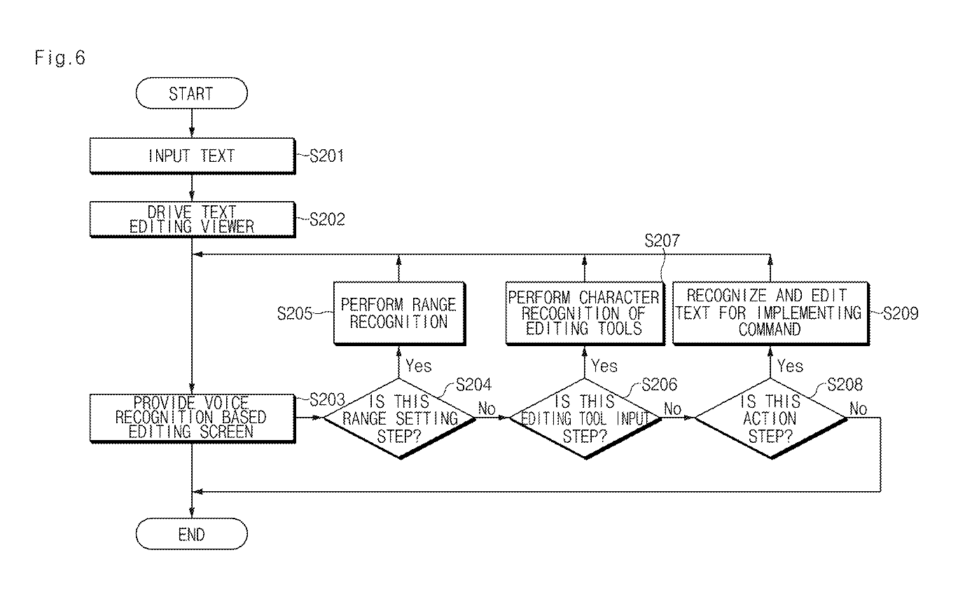

Hereinafter, a character recognition based editing method according to a second exemplary embodiment of the present invention will be described with reference to FIGS. 6 to 8.

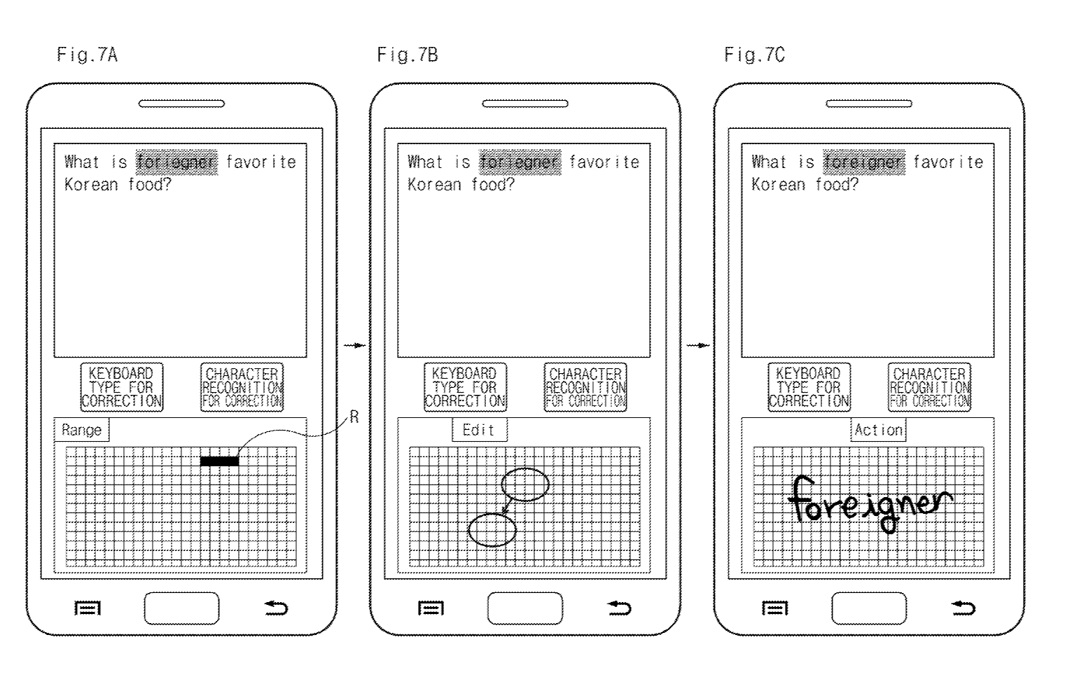

As illustrated in FIG. 6, when a text is input in step S201, a control unit 400 drives a text editing viewer in step S202 to provide a character recognition based editing screen to an interface unit 100 in step S203. In this case, the character recognition based editing screen provides a step of setting a range (Range) (as illustrated in FIG. 7A), a step of selecting an editing tool (Edit) (as illustrated in FIG. 7B), and a step of inputting action (Action) (as illustrated in FIG. 7C).

First, the control unit 400 provides a screen of the step of setting a range (FIG. 7A) through the interface unit 100 and checks whether a range setting is input from the user in step S204. When a part R corresponding to a position of the text which is input from the user in the step of setting a range is set by a finger or a pen, a character recognition editing unit 320 recognizes a range of the text to be edited in step S205. Next, the control unit 400 continuously provides the character recognition based editing screen to receive the next command in step S203 and subsequent processes may be repeatedly performed.

In the meantime, when the step is not the step of setting a range in step S204, the control unit 400 provides a screen for an editing tool input step (FIG. 7B) and checks whether an editing tool symbol is input from the user through the interface unit 100 in step S206 and when the editing tool symbol is input, the character recognition editing unit 320 recognizes an input editing tool symbol in step S207. Next, the control unit 400 continuously provides the character recognition based editing screen to receive the next command in step S203 and subsequent processes may be repeatedly performed. In this case, the editing tool symbol is created as a table with a symbol and a meaning thereof as illustrated in FIG. 8 and stored in the storing unit 500.

In the meantime, when the step is not the step of inputting an editing tool in step S206, the control unit 400 provides a screen for a command performing step screen (FIG. 7C) and checks whether a command action is input from the user through the interface unit 100 in step S208 and when the command action is input, the character recognition editing unit 320 recognizes the input command action and performs editing in step S209. Next, the control unit 400 continuously provides the character recognition based editing screen to receive the next command in step S203 and subsequent processes may be repeatedly performed.

An example of a character recognition based editing method according to a second exemplary embodiment of the present invention will be described below with reference to FIG. 7A, FIG. 7B and FIG. 7C.

FIG. 7A is an exemplary diagram illustrating a position or region setting function which is a first character recognition based function for correction. In the exemplary diagram, when a position or region to be edited is drawn on a recognition screen for correction with a pen, a corresponding position or region of the text editing viewer is activated. A button indicating a screen region (Range) is activated at an upper left of the recognition screen for correction. This function is activated by clicking the character recognition button for correction and when other correcting functions end, the function is activated again.

FIG. 7B is an exemplary diagram of a screen which displays, when a position or range to be edited by FIG. 7A is determined, a function of inputting an editing character which is to be edited in a text in the position or range and recognizing the editing character. In this exemplary diagram, a function of inputting and recognizing a correcting character which is replaced for the text in the editing range as a format is performed.

Referring to FIG. 7C, a screen which completes a function of recognizing an editing target character (character to be replaced) for the replacement (correction) of FIG. 7B and replacing contents in the corresponding text position with another text is illustrated. “foreigner” which is a text which is newly added is replaced for a character string in a corresponding range through the format recognition to complete a function of correcting a text error. Such a function may be completed by a text input machine and voice input and may be completed by being combined with the keyboard type interface for correction in this case. This step is a third correcting character recognition step and a last completion step and an expression indicating “action” is activated at an upper center of the correcting character recognizing screen.

In this case, as illustrated in FIG. 8, the editing tool may include various buttons such as delete, insert, position switch, and space in addition to the replace in the character recognition based editing screen. The editing tools are not newly defined in the present invention and follow a generally used method in text correcting so that not all the editing tools will be described herein. However, it is assumed that all the editing tool symbols which are frequently used may be used in the character recognition based text editing method of the present invention and recognized by a character recognizing machine.

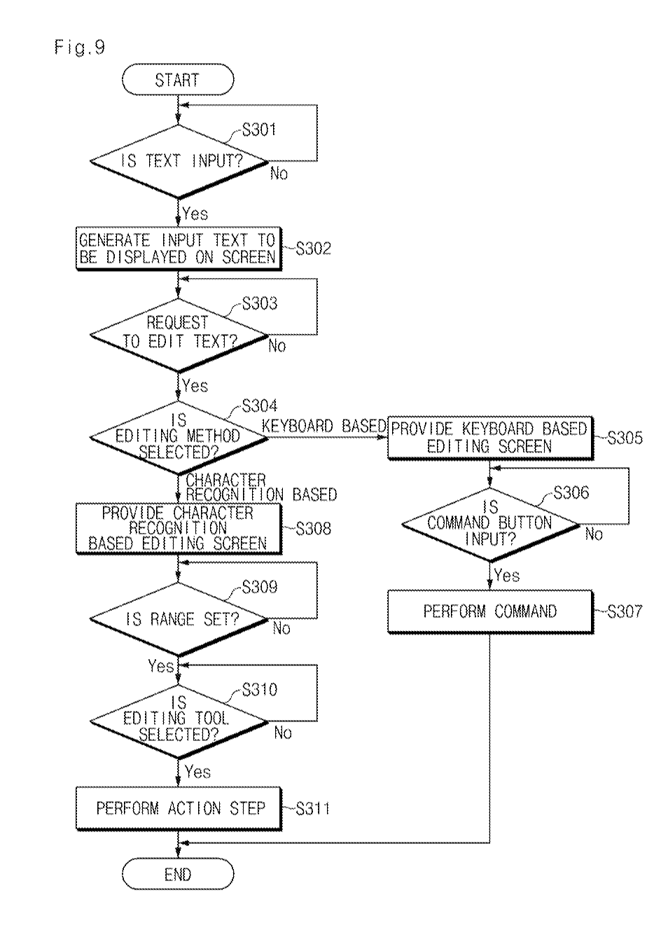

Hereinafter, a text editing method according to a third exemplary embodiment of the present invention will be described with reference to FIG. 9.

First, a control unit 400 checks whether a text is input through an interface unit 100 is step S301 and when the text is input, controls the input text to be displayed through the interface unit 100 in step S302.

The control unit 400 checks whether a text editing request is input from the user through the interface unit 100 in step S303 and when the editing request is input, allows the user to select an editing method in step S304.

When the editing method which is selected by the user is a keyboard based editing method, the control unit 400 provides a keyboard based screen through the interface 100 in step S305. Therefore, the keyboard recognizing unit 230 checks whether an editing command button is input from the user through a keyboard based editing screen in step S306 and when the editing command button is input, the keyboard based editing unit 610 performs the editing command in step S307.

In contrast, when the editing method which is selected by the user in step S304 is a character recognition based editing method, the control unit 400 provides a character recognition based editing screen through the interface unit 100 in step S308. Therefore, a touched character recognizing unit 220 checks whether a range setting input is generated from the user through the character recognition based editing screen in step S309 and when the range is set, checks whether the editing tool is selected by inputting an editing tool symbol from the user in step S310. Next, the character recognition based editing unit 620 performs a command by the character recognition in step S311.

As described above, the functions disclosed in FIGS. 4 to 9 are an example of an editing form which may be applied to a portable terminal but the noted function or order is not limited to the part introduced in the present invention but may be various.

An embodiment of the present invention may be implemented in a computer system, e.g., as a computer readable medium.

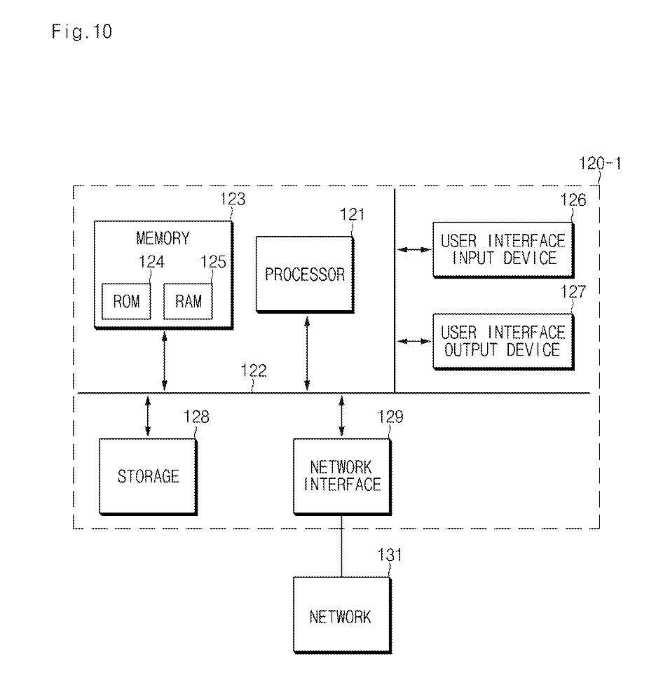

FIG. 10 is a configuration diagram of a computer system applied a text editing system according to an exemplary embodiment of the present invention.

As shown in FIG. 10, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 131. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, in a portable terminal in which means such as a key pad which is an interacting means between the user and the terminal and voice input are very restricted, a large amount of text is easily edited so that convenience of the user may be increased and a voice translation quality may be improved.

While the exemplary embodiments of the present invention have been described for illustrative purposes, it should be understood by those skilled in the art that various changes, modifications, substitutions, and additions may be made without departing from the spirit and scope of the present invention as defined in the appended claims and such changes and modification belong to the following claims.

What is claimed is:

1. A text editing system of a portable terminal, comprising:
an interface unit which inputs or outputs a text or voice;
a text generating unit which generates the input text or voice as a text;
a control unit which provides a keyboard based editing screen or a character recognition based editing screen for the generated text through the interface unit; and
a text editing unit which performs an editing command which is input from a user through the keyboard based editing screen or the character recognition based editing screen under the control of the control unit.

2. The text editing system of claim 1, further comprising:
a touched character recognizing unit which recognizes a character input from the character recognition based editing screen.

3. The text editing system of claim 1, wherein the touched character recognizing unit sets a range of a part to be edited in the text and when the range is set, receives and recognizes an editing tool symbol.

4. The text editing system of claim 1, further comprising:
a keyboard recognizing unit which recognizes touch or click of an editing button which is input from the keyboard based editing screen.

5. The text editing system of claim 1, wherein the keyboard based editing screen includes:
a text part which displays the text; and
a keyboard type button part which includes an editing button which is driven in accordance with a touch screen manner.

6. The text editing system of claim 5, wherein the keyboard type button part includes at least one of a copy button, a paste button, a delete button, an insert button, a replace button, a dictionary button, a translate button, a search button, a voice recognition button, a number button, and a symbol button.

7. The text editing system of claim 1, wherein the character recognition based editing screen includes:
a text part which displays the text; and
a character recognition input unit in which a range, an editing tool symbol, and a target for action are drawn by a pen or a finger to be input.

8. The text editing system of claim 7, further comprising:
a voice recognizing unit which recognizes voice input through the interface unit and converts the voice into the text.

9. The text editing system of claim 1, further comprising:
a storing unit in which the keyboard based editing screen, the character recognition based editing screen, the input text, and a character recognition based editing tool symbol table are stored.

10. A text editing method of a portable terminal, comprising:
displaying a text on a screen;
providing a keyboard based editing screen for the text displayed on the screen; selecting a range of a text to be edited from the keyboard based editing screen; and
performing a touched or clicked editing command on a text whose range is selected when an editing command button is touched or clicked by a user through the keyboard based editing screen.

11. The text editing method of claim 10, wherein the keyboard based editing screen includes:
a text part which displays the text; and
a keyboard type button part which includes the editing command button.

12. The text editing method of claim 10, wherein the editing command button further includes at least one of a replace button, a copy button, a paste button, a delete button, an insert button, a dictionary button, a translate button, a search button, a voice recognition button, a number button, and a symbol button.

13. A text editing method of a portable terminal, comprising:
displaying a text on a screen;
providing a character recognition based editing screen for the text displayed on the screen;
setting a range of a text which is edited in the character recognition based editing screen;
receiving and recognizing an editing tool symbol for editing a text in the set range by a user; and
performing editing by the recognized editing tool.

14. The text editing method of claim 13, wherein the character recognition based editing screen includes:
a text part which displays the text; and
a character recognition input unit which recognizes an editing range, an editing tool symbol, and an editing action based on a touch interface.

15. The text editing method of claim 14, wherein in the setting of a range of a text which is edited, when an editing position or range is selected through the character recognition input unit by the user, a text in the corresponding position of the text part is activated.

16. The text editing method of claim 13, wherein in the receiving and recognizing of an editing tool symbol from the user, when the editing tool symbol is drawn by the user, a meaning corresponding to the drawn editing tool symbol is determined from an editing tool symbol table which is stored in advance.

17. The text editing method of claim 13, wherein the performing of editing performs editing corresponding to the meaning of the editing tool symbol.

18. The text editing method of claim 13, wherein the performing of editing when the editing tool symbol is replace, receives a new text to be replaced to perform replacement.

19. A text editing method of a portable terminal, comprising:
displaying an input text on a screen;
selecting, by a user, an editing method for the input text;
providing a keyboard based editing screen when a keyboard based editing method is selected by the user among the editing methods and providing a character recognition based editing screen when a character recognition based editing method is selected by the user among the editing methods;
receiving an editing command from the user through the keyboard based editing screen or the character recognition based editing screen; and
performing the input editing command to edit the text.

20. The text editing method of claim 19, wherein the character recognition based editing screen includes:
a text part which displays the text; and
a character recognition input unit which recognizes an editing range, an editing tool symbol, and an editing action based on a touch interface.
